(19) United States
(12) Patent Application Publication
(10) Pub. No.: US 2026/0203869 A1
(43) Pub. Date: Jul. 16, 2026

(54) METHODS TO IMPROVE VIDEO INPAINTING THROUGH DIFFUSION MODELS

(71) Applicant: Adeia Guides Inc., San Jose, CA (US)

(72) Inventor: Tao Chen, Palo Alto, CA (US)

(21) Appl. No.: 19/021,678

(22) Filed: Jan. 15, 2025

(51) Int. Cl. G06T 5/60; G06T 5/77; G06V 10/25; G06V 10/26; G06V 10/74; G06V 10/762; G06V 20/40

(52) U.S. Cl. CPC G06T 5/60; G06T 5/77; G06V 10/25; G06V 10/26; G06V 10/761; G06V 10/7625; G06V 20/49; G06T 2207/10016; G06T 2207/20104

(57) ABSTRACT

Systems and methods are provided herein for intelligently inpainting videos via multi-temporal diffusion models by utilizing multiple anchor frames. Particularly, systems and related methods are disclosed for analyzing frames of a video to determine a proper organizational structure, grouping the frames based on the organizational structure, selecting an anchor frame for each group, and inpainting the frames based on the respective groups and anchor frames to generate a modified video. During inpainting, the organizational structure and selected anchor frames may be leveraged to provide an additional attention guidance mechanism to the diffusion model. Upon generating a modified video, the system assesses the color consistency of the video and, if necessary, de-colorizes and then re-colorizes the video to improve temporal consistency.

### BACKGROUND

This disclosure is related to techniques for video inpainting, and more particularly to analyzing object depiction within the frames of a video to be modified to provide intelligent use of diffusion models.

### SUMMARY

Video inpainting using multitemporal diffusion models represents a significant advancement in the field of video processing and editing. A diffusion model is a generative machine learning model, running on hardware, that is trained using an operation or process that includes two steps or processes that may be iterated to improve the model: diffusion and reverse diffusion. In a first step, the diffusion model adds noise to training data (e.g., video or images) until the training data is transformed into random noise (this may be referred to as a diffusion process). Then, in a second step, the model learns to reverse the process of adding noise, gradually reconstructing data from pure noise into meaningful samples that resemble the original training data (this may be referred to as a reverse diffusion process). This denoising happens incrementally, transforming a noisy sample into a slightly less noisy one at each step. By learning to obtain something resembling the original training data by way of this denoising process, the diffusion model can be used to denoise real-world data (i.e., not training data) similar to the training data to generate a higher-quality version of noisy data (e.g., a low-quality video or image).

A multitemporal diffusion model is a type of diffusion model designed to handle time series data across multiple temporal resolutions or time scales. The model breaks down time series data into different time scales, like hourly, daily, weekly, or monthly patterns. In an example approach, the model predicts broad, long-term patterns (like yearly trends), then gradually adds more detailed patterns (like daily variations). Each prediction builds upon the previous ones, creating increasingly detailed forecasts. This approach can be useful for forecasting complex time series data where patterns exist at multiple time scales, such as energy consumption data that might have both daily usage patterns and seasonal trends.

Multitemporal diffusion models can be used to facilitate video inpainting. In an example approach, video inpainting is a process in which missing or damaged parts of a video are “filled in.” The model looks at multiple frames at a given time and “fills in” or replaces missing areas while attempting to ensure that the movement and content stay smooth and natural across time. Stated more specifically, this video inpainting approach leverages the power of generative diffusion models to reconstruct a masked region in video frames, such as a missing or corrupted region or an object of interest. For example, video inpainting systems may encode video frames into a latent space where patterns and relationships between pixels are captured and then utilize diffusion models to iteratively refine the inpainting process by simulating a noise-adding and denoising cycle, gradually reconstructing the masked regions. A latent space is a map, or representation, of data where similar items are grouped together. The latent space serves as an abstract multi-dimensional space that can capture the essential features and patterns of data while reducing its complexity. For example, in video processing, similar frames or motion patterns may be positioned near each other in this space.

In some embodiments, video inpainting may be used to reconstruct masked regions. For example, in current approaches, when utilizing video inpainting to modify an object within the video, such as changing a softball into a baseball, video editing systems, running on hardware, receive input and, based on the received input, select an anchor frame to generate a mask of the object of interest (e.g., the softball), propagate the generated mask to all frames in the video containing the object of interest, and inpaint the masked regions to reflect the desired change (e.g., replace the softball with a baseball) by leveraging a diffusion model. By further incorporating multitemporal information via analyzing both past and future frames, these models, such as AVID (Any-Length Video Inpainting), capture the spatiotemporal dynamics of the scene, enabling temporal coherence, high-quality visual details, smooth transitions, and realistic inpainting. For example, when provided with a video, a masked region at its initial frame, and an editing prompt, AVID, equipped with effective motion modules and adjustable structure guidance, leverages a diffusion model to do infilling at each frame by following the editing guidance while keeping the out-of-mask region intact. The technique may be used in areas such as video restoration, object removal, and content editing, offering a solution to challenges that conventional methods often struggle to address. However, when inpainting videos, especially long videos, identity shift occurs as small differences or errors accumulate.

Generally, “identity shift” refers to a phenomenon in which an object's appearance—its color, size, or position—can change in small but noticeable ways over time as the video plays, making the inpainted video look unnatural. In other words, while each individual frame might look fine after inpainting, non-negligible inconsistencies, such as slight changes in an object's color or position, build up over many frames, thus creating a noticeable shift in the appearance of objects.

In some approaches, to address identity shift, a middle-frame attention guidance mechanism may be utilized with video inpainting systems. Such approaches may use the middle frame of the video as a reference point to maintain consistency while inpainting. Middle-frame attention guidance may cause the statistics of the frame in the middle of the video to be retained in generating the other frames at inference, during each denoising step, and within every self-attention layer. For each frame, an auxiliary attention feature map may be subsequently fused with the existing self-attention feature map within the same layer to improve temporal consistency. For example, in some approaches, inpainting models generate a query matrix (e.g., Q), a key matrix (e.g., K), and a value matrix (e.g., V) for each frame and, when inpainting a video with N′ frames, retain the keys and values of the middle frame of a video (e.g., K^{[N′/2]}, V^{[N′/2]}) in order to leverage an attention formulation for each frame (e.g., Attention(Ψi)=softmax((QⁱK^{i∧T})/√(d))Vⁱ·(1−ω)+softmax((Qⁱ K^{[N′/2]∧T})/∞(d)V^{[N′/2]}·ω) to help mitigate identity shift issues. While middle-frame attention guidance helps to improve identity consistency and enables synchronization of temporal and spatial cues, undesirable color variations can occur due to an over-reliance on the middle frame of the video. Specifically, while consistency may be maintained for frames close to the middle of the video, inpainted areas of frames farther from the middle become less accurate relative to the frames that are closer to the middle frame. Additionally, middle-frame attention guidance can result in positioning errors as each frame in the video is influenced by how the inpainting aligns with the middle frame. Small misalignments in positioning can occur frame by frame, and these errors can accumulate over time, especially in longer videos. That is, the farther a frame is from the middle, the more likely it is that objects will be positioned incorrectly, causing noticeable “drifts” in object placement. Further, if the algorithm does not accurately estimate or follow the movement of objects in earlier or later frames, objects may begin to follow an incorrect trajectory.

Additionally, in some approaches, video inpainting systems may use information from earlier frames to predict and fill in missing areas in later frames. Over time, the inpainted regions in each frame begin to deviate from the original appearance of the object, referred to as reference drift. This “drift” becomes more pronounced as the video goes on, causing objects to gradually change in color, size, shape, and/or position. Further, to maintain consistency, it may be beneficial to have a broad array of data indicating how objects should appear throughout the entire sequence of frames, not just in the nearby frames, to maintain consistency. Thus, in some instances, such as in longer videos, video inpainting systems struggle to capture this global context, especially as these systems often rely on immediate neighboring frames for guidance. Video inpainting systems additionally face temporal blending challenges, since ensuring that objects remain temporally consistent across a large number of frames is hard, due to the desire to balance maintaining consistency with the changing dynamics of the video, such as motion or lighting.

To help address these problems, the disclosed techniques may be implemented to facilitate improved video inpainting in a manner that mitigates the risk of small changes accumulating into a noticeable identity shift within a video being inpainted. Systems and methods are disclosed herein for, among other things, intelligently grouping frames of a video (e.g., hierarchically, linearly, via a sliding window), leveraging a respective anchor frame for each group to generate masked regions for each frame, and inpainting the masked regions of the frames to generate a modified video. For example, in some implementations, a video editing system (e.g., a server, client, or distributed system) accesses a video and receives an input comprising (a) a selection of an object of interest within a frame of the video and (b) an indication to apply a modification to the object of interest in a plurality of frames of the video that depict the object of interest. In some embodiments, the video editing system comprises instructions stored in the non-transitory memory of the video editing system that enables a video editing application to perform any of the disclosed methods. In some embodiments, the video editing system groups the plurality of frames into a plurality of groups of frames based on similarity of depiction of the object of interest in the plurality of frames. In some implementations, the video editing system, for each respective group of frames of the plurality of groups, selects at least one respective anchor frame and generates a respective mask that defines a region depicting at least a portion of the object of interest in the at least one respective anchor frame. In some embodiments, the video editing system causes the object of interest within each frame of the plurality of frames to be inpainted by an inpainting artificial intelligence model, thus generating a respective group of modified frames. In some implementations, the video editing system generates for output a modified video based on each respective group of modified frames.

Such systems and methods, for example, analyze frames of a video in order to generate appropriate masks for each frame in an intelligent manner, thus limiting the risk of small changes accumulating into a noticeable identity shift within the video. By utilizing pre-processing techniques to streamline the inpainting process, such systems and methods provide improved inpainting results while simultaneously optimizing energy usage. For example, in some embodiments, a video editing system provided with a video of a car doing donuts and instructions to replace the car with a different type (e.g., replace a sports car with a minivan) groups the frames corresponding to the different regions of the donut (e.g., the northern region of the donut, the north eastern region of the donut, the eastern region of the donut, etc.) and selects a unique anchor frame for each group to generate and propagate a mask from. Further, for example, in some implementations, the video editing system builds a hierarchy of frames based on the similarity of the depiction of the object to be replaced and/or removed (e.g., frames depicting the car facing towards the camera and away from the camera are mapped to a hierarchy that organizes the frames based on their respective similarities to one another) and groups the frames accordingly. By then inpainting regions of the frames of the video in batches corresponding to the groups, the video inpainting system minimizes errors and identity shift, and saves energy and bandwidth by decreasing the variation the multitemporal diffusion model faces in each group of frames to be inpainted.

Additionally, in some embodiments, the video editing system groups the plurality of frames into the plurality of groups of frames based on a linear order of occurrence of the plurality of frames in the video. In some implementations, the video editing system groups the plurality of frames into the plurality of groups of frames by organizing the plurality of frames into a hierarchical order based on a similarity factor between the plurality of frames. In some embodiments, the video editing system uses an inpainting artificial intelligence model that comprises a temporal multi-diffusion model that is configured to receive, as input, a subset of frames, an indication of anchor frames within the subset of frames, the respective masked region of each anchor frame, and replacement data for the object of interest. In some implementations, the temporal multi-diffusion model leverages at least one of (a) a middle-frame attention guidance mechanism for the plurality of frames, (b) a respective anchor frame attention guidance mechanism for each respective group of the plurality of groups of masked frames, or (c) a comprehensive attention guidance mechanism based on a subset of frames of the plurality of frames. For example, in some embodiments, the video editing system uses an attention formulation that leverages a respective anchor frame (“RAF”) of a respective group for each frame of the respective group (e.g., Attention(Ψi)=softmax((Qⁱ K^{i∧T})/√(d))Vⁱ·(1−ω)+softmax((Qⁱ K^{[RAF]∧T})/√(d))V^{[RAF]}·ω) or an attention formulation that leverages multiple anchor frames (e.g., AF1, AF2, . . . ) for each frame (e.g., Attention(Ψi)=softmax((QⁱK^{i∧T})/√(d))Vⁱ·(1−ω)+(softmax(Q¹ K^{[AF1]∧T})/√(d)V^{[AF1]}·ω+softmax(Qⁱ K^{[AF2]∧T})/√(d)V^{[AF2]}·ω)/2) In some embodiments, when a particular frame belongs to at least two groups of the plurality of groups and groups of modified frames comprise at least two modified particular frames associated with the respective group of the at least two groups of the plurality of groups, the video editing system generates for output the modified video by comparing the at least two modified particular frames to identify a preferred modified frame and selecting the preferred modified frame to be used in the modified video.

In some embodiments, the video editing system receives a text prompt indicating the object of interest to be modified and an indication of a specific modification to be made to the object of interest. In some implementations, the video editing system determines the similarity of depiction of the object of interest in the plurality of frames by generating a preliminary mask that defines a shape of the object of interest in an initial anchor frame, propagating the preliminary mask to each frame of the plurality of frames, and comparing the masked region of each frame to determine the similarity of depiction of the object of interest in the plurality of frames. In some embodiments, the video editing system selects the at least one respective anchor frame based on at least one of an object of interest complexity, an object of interest motion pattern, a linear distance between the respective anchor frame and each frame in the respective group, or similarity of the depiction of the object of interest in the at least one respective anchor frame as compared to the other frames in the respective group. In some implementations, the video editing system propagates the respective mask of each anchor frame to each frame of the respective group to define a respective masked region to be inpainted for each frame and inpaints the respective masked region of each frame using the inpainting artificial intelligence model. In some embodiments, the inpainting artificial intelligence model infers regions to be inpainted within each frame of a respective group of frames based on the respective anchor of the group of frames and the respective masked region of the respective anchor frame.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A depicts an illustrative system for leveraging an inpainting model and frame analysis to intelligently replace an object in a video, in accordance with some embodiments of this disclosure.

FIG. 1B depicts an illustrative example of selecting a single modified frame from a group of modified frames to generate a modified video, in accordance with some embodiments of this disclosure.

FIG. 1C depicts an illustrative example of generating a respective mask for multiple anchor frames, in accordance with some embodiments of this disclosure.

FIG. 2A depicts an illustrative system for leveraging an inpainting model and frame analysis to intelligently replace an object in a video, in accordance with some embodiments of this disclosure.

FIG. 2B depicts an illustrative example of selecting a single modified frame from a group of modified frames to generate a modified video, in accordance with some embodiments of this disclosure.

FIG. 3 depicts an illustrative example of hierarchical temporal multi-diffusion, in accordance with some embodiments of this disclosure.

FIG. 4 depicts an illustrative example of sequential temporal multi-diffusion, in accordance with some embodiments of this disclosure.

FIG. 5 depicts an illustrative example of applying color transfer, de-colorization, and re-colorization in temporal multi-diffusion, in accordance with some embodiments of this disclosure.

FIG. 6 shows illustrative devices and systems for leveraging an inpainting model and frame analysis to intelligently replace an object in a video, in accordance with some embodiments of this disclosure.

FIG. 7 shows illustrative devices and systems for leveraging an inpainting model and frame analysis to intelligently replace an object in a video, in accordance with some embodiments of this disclosure.

FIG. 8 is flowchart of a detailed illustrative process for leveraging an inpainting model and frame analysis to intelligently replace an object in a video, in accordance with some embodiments of this disclosure.

### DETAILED DESCRIPTION

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

The disclosed methods and systems enhance video inpainting capabilities by grouping frames to improve the inpainting process, thereby minimizing errors and inconsistencies. The system includes several components designed to analyze and group video frames based on various parameters related to an inpainting request, to ensure streamlined inpainting and modified video generation.

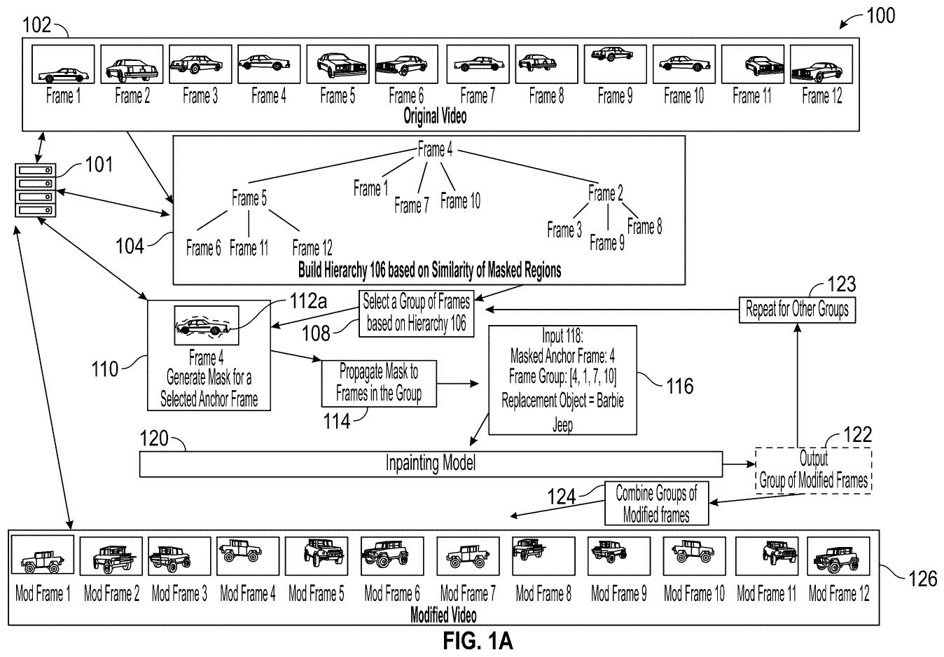

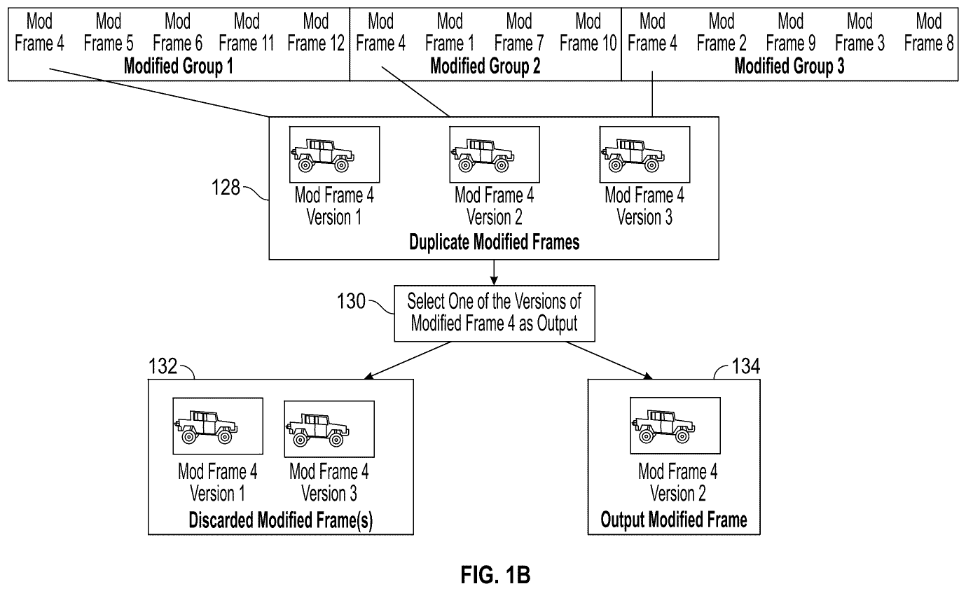

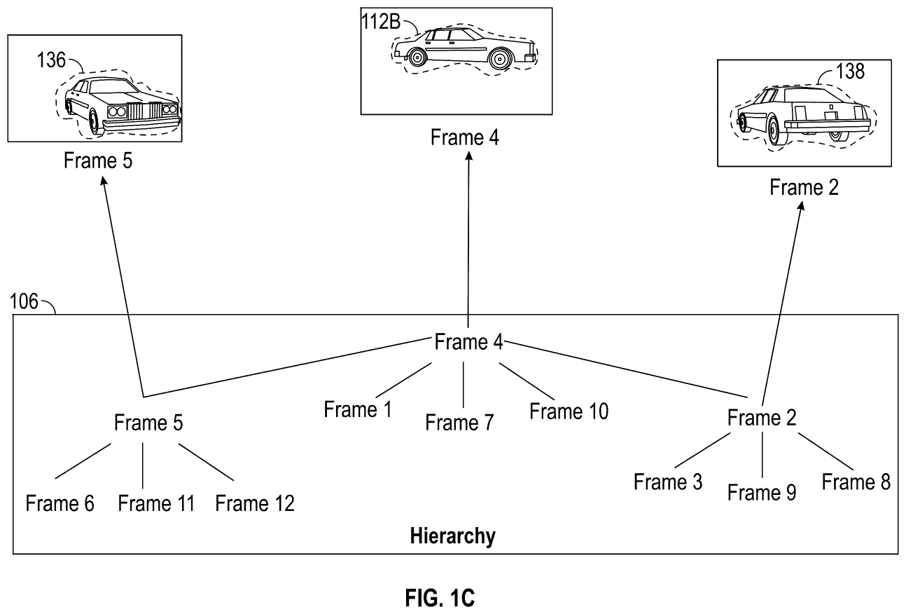

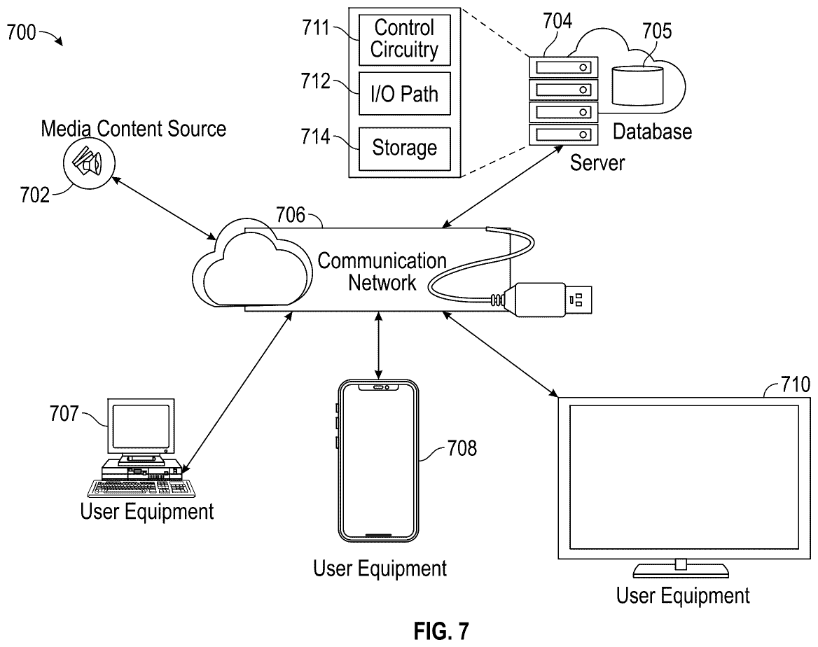

FIGS. 1A-1C depict system 100 for leveraging an inpainting model and frame analysis to intelligently replace an object in a video, in accordance with some embodiments of this disclosure. In some embodiments, system 100 (also referred to herein as “the system”) may comprise or correspond to and/or be implemented by server 101 of a video editing service (e.g., Adobe, Movavi, Vimeo, etc.), a media sharing service (e.g., TikTok, Instagram, etc.), any suitable video editing service, or any other suitable device, service, or platform, or any combination thereof. The system may comprise or correspond to a video editing application (e.g., instructions stored in non-transitory memory, that when executed by control circuitry of system 100, cause transmittal or analysis of data and generation of user interfaces to be displayed) (e.g., Adobe), which may be executed at least in part on devices 707, 708, and/or 710 of FIG. 7 and/or at one or more remote servers (e.g., server 101, server 704 of FIG. 7 and/or media content source 702 of FIG. 7) and/or at or distributed across any of one or more other suitable computing devices or network equipment, in communication over any suitable number and/or types of networks (e.g., the Internet, cellular networks, satellite networks, and/or any other suitable networks). The video editing application may be configured to perform the functionalities (or any suitable portion of the functionalities) described herein. In some embodiments, the video editing application and/or the system may be a stand-alone application or may be incorporated as part of any suitable application or system. The video editing application and/or system may comprise or employ any suitable number of displays, sensors or devices such as those described in FIGS. 1-8, or any other suitable software and/or hardware components, or any combination thereof.

In some embodiments, the application may be installed at or otherwise provided to a particular computing device, may be provided via an application programming interface (API), or may be provided as an add-on application to another platform or application. In some embodiments, software tools (e.g., one or more software development kits (SDKs)) may be provided to any suitable party, to enable the party to implement the functionalities described herein.

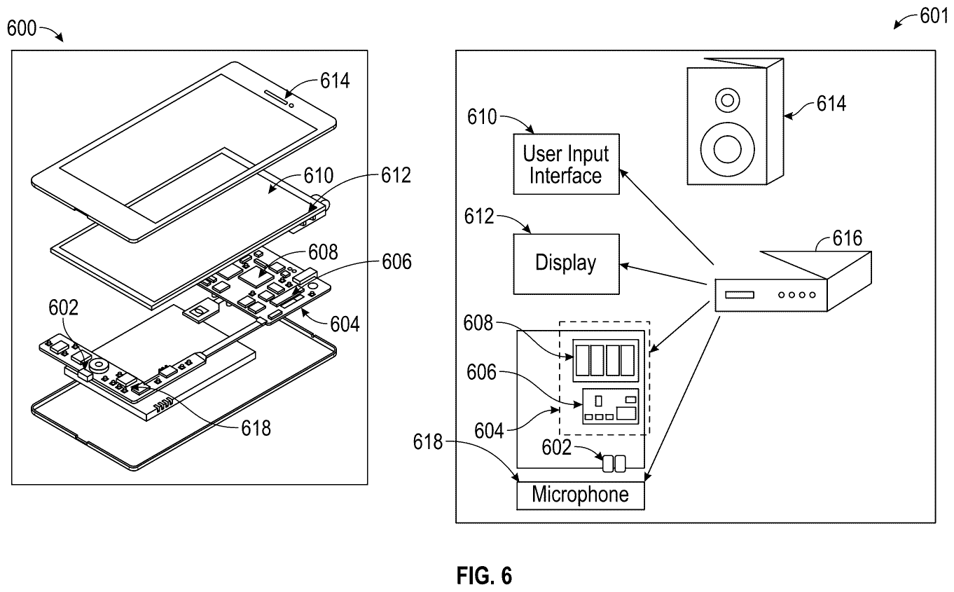

In some implementations, system 100 may comprise devices 707, 708, and/or 710 of FIG. 7, or any number of devices, comprising software and hardware components, such as, for example, control circuitry and memory. In some embodiments, the control circuitry of devices 707, 708, and/or 710 of FIG. 7 is control circuitry 604, as further described in FIG. 6 below. The hardware components and applications installed on devices 707, 708, and/or 710 of FIG. 7 are managed by an operating system (OS) (e.g., iOS, Android, webOS). System 100 may execute the process depicted in FIGS. 1A-1C based on instructions stored in non-transitory memory (e.g., non-transitory memory 608 of FIG. 6, or storage 714 of FIG. 7). System 100 may enable user devices, such as devices 707, 708, and/or 710 of FIG. 7, to access digital content (e.g., images, videos) stored by digital content providers (e.g., YouTube, Facebook, Google, etc.) over any suitable network (e.g., the Internet, cellular networks, or any other suitable network, or any combination thereof), such as communication network 706 of FIG. 7. System 100 may access digital content stored by other applications on user devices, such as videos or images received via a messaging app or stored in a photos app. System 100 may access the applications installed on user devices running the video editing application by using an API, a software interface that allows two or more applications to communicate with each other.

In some embodiments, any of the user devices running the video editing application may be a mobile device such as, for example, a smartphone or tablet. In some embodiments, any of the user devices running the video editing application may comprise or correspond to a laptop computer, a personal computer, a desktop computer, a smart television, a smart watch or wearable device, smart glasses, a stereoscopic display, a wearable camera, extended reality (XR) glasses, XR goggles, a near-eye display device, or any other suitable user equipment or computing device, or any combination thereof.

As shown in FIG. 1A, in some embodiments, system 100, as supported by and run through server 101, accesses original video 102, comprising frames 1-12, or any number of suitable frames. In some embodiments, system 100 accesses original video 102 comprising 12 frames of a muscle car doing donuts. In some implementations, system 100 receives original video 102 as an upload from a user (e.g., a user supplies original video 102 directly to system 100). For example, in some implementations, system 100 is implemented within a media sharing application, such as Instagram, and system 100 receives original video 102 as a potential post to the media sharing application. In some embodiments, system 100 is implemented within a video and/or photo storage application and automatically identifies original video 102 to be modified. In some embodiments, system 100 accesses original video 102 from a secondary application installed at the device providing user access to system 100. For example, in some implementations, system 100 is a video editing application installed on a mobile phone that is allowed to access all photos and videos stored in the native OS photos application. Further, for example, in some embodiments, system 100 receives an instruction to access original video 102 from a third-party source, such as a secondary application accessible via an API or a digital content provider accessible via a suitable network (e.g., the Internet, cellular network). For example, in some implementations, system 100 receives an upload of original video 102 and an input (e.g., voice, textual, selection based, or any other suitable input or combination thereof) indicating that the muscle car in the video is to be replaced with a Barbie Jeep. In some embodiments, system 100 receives an upload of image data for the replacement (e.g., an image of a Barbie Jeep), a textual description of the replacement (e.g., “a bright pink Jeep that Barbie would be proud to drive around in”), or any other suitable indication of a replacement, or other comparable edit, to be made. For example, in some implementations, system 100 receives an input (e.g., voice input, textual input) stating “generate a video of a Barbie Jeep doing donuts,” and subsequently searches the Internet to find a video of a car doing donuts (e.g., original video 102) and an image of a Barbie Jeep. In some embodiments, system 100 receives the input to generate the video of the Barbie Jeep doing donuts and subsequently searches within its own database to retrieve a video of a car doing donuts and an image of a Barbie Jeep. In some implementations, system 100 receives an input stating “Please replace Laurel in the video Camille just texted me with my dad,” and subsequently accesses the messaging application on the device to identify the video (e.g., original video 102) that was just texted to the user by “Camille” and accesses a facial database (e.g., Google Photos where the user has labeled common faces with names) to identify target facial data (e.g., Laurel) and its corresponding replacement facial data (e.g., “my dad”).

In some embodiments, system 100 receives an input comprising (a) a selection of an object of interest within a frame, and (b) an indication to apply a modification to the object of interest in a plurality of frames of the video that depict the object of interest. For example, in some implementations, system 100 receives original video 102 as an upload, receives an indication that an object in the video is to be replaced (e.g., a selection of an object replacement checkbox of a plurality of checkboxes corresponding to video editing processes that system 100 is capable of), provides a plurality of objects within that video to be replaced (e.g., tree, sun, muscle car), receives a selection of the object of interest (e.g., the muscle car), receives an indication of a replacement object to replace the object of interest with (e.g., receives a replacement image as an image upload, provides a plurality of replacement object options and receives a selection of a replacement object, receives a voice or textual input describing the replacement object), or any suitable combination thereof. In some embodiments, system 100 receives an input comprising any suitable video content editing request such as to add a new object to the video (e.g., add a sidecar to the car that is doing donuts), modify the appearance, texture, color, size, material, or any other suitable aspect of an object (e.g., change the car from shiny red to matte navy blue), restore a corrupted region of the video (e.g., make it so that no one would ever know that I was accidentally covering half the camera with my finger while filming my sister's once-in-a-lifetime accomplishment), or any other suitable editing request. In some embodiments, system 100 analyzes original video 102 to determine a suitable video content editing request (e.g., determines that a finger is overlaying a portion of a video and subsequently determines that the finger should be removed and the corresponding region needs to be inpainted). In some implementations, system 100 is configured to receive an editing request via a text prompt, a voice prompt, via receiving step-by-step selections of various editing options provided by system 100, or via any other suitable mechanism. In some implementations, system 100 analyzes original video 102 to determine an appropriate action to perform (e.g., determines that a corrupted region in a subset of the frames of original video 102 needs to be inpainted).

As shown in FIG. 1A, in some embodiments, system 100, at 104, builds hierarchy 106 based on similarity of masked regions. In some embodiments, system 100 builds hierarchy 106 by analyzing the complexity of the object of interest, the movement patterns of the object of interest, the linear order of the frames of original video 102 (e.g., in either a forward or backward direction), or any suitable indication of similarity between the depiction of the object of interest within the various frames of original video 102. For example, in some implementations, system 100 selects an initial anchor frame from original video 102, generates a preliminary mask that defines a shape of the object of interest in the initial anchor frame, propagates the preliminary mask to each frame of the plurality of frames, compares the masked region of each frame to determine the similarity of depiction of the object of interest in the plurality of frames, builds hierarchy 106 based on the determined similarity of depiction of the object of interest in the plurality of frames, or any suitable combination thereof. In some implementations, system 100 builds and stores hierarchy 106 as a data structure (e.g., a tree, a linked list, a representative map, a categorical table, or any other suitable structure or combination thereof) that represents the similarity between each frame (e.g., including anchor frames) (e.g., more similar frames are stored as having a stronger and/or closer link as compared to less similar frames that are stored as having a weaker and/or farther link). In some embodiments, system 100 builds and stores hierarchy 106 as a data structure that represents the similarity between frames as compared to selected anchor frames (e.g., when anchor frames are initially selected based on a determined quality of frames). In some embodiments, system 100 identifies a plurality of frames of the frames of original video 102 that require inpainting (e.g., contain the object of interest, are corrupted, correspond to the received editing prompt). For example, in some implementations, when system 100 receives original video 102 comprising a person running through a forest and the input “Replace the sun with the moon,” system 100 identifies each frame of original video 102 that contains the sun to determine a plurality of frames for inpainting and builds hierarchy 106 based on the similarity of the sun's depiction in the plurality of frames. In some embodiments, system 100 configures hierarchy 106 so that all frames share a common frame (e.g., frame 4). In some implementations, system 100 configures hierarchy 106 to contain independent hierarchical groups (e.g., frames 5, 6, 11, and 12 comprise a first mini hierarchy; frames 4, 1, 7, and 10 comprise a second mini hierarchy; etc.). In some embodiments, system 100 configures hierarchy 106 to organize the frames (e.g., the frames of original video 102, the plurality of frames requiring inpainting) in any matter to effectively sort the frames according to a similarity factor (e.g., linear location in original video 102, scene depiction, object of interest depiction, lighting, etc.). In some implementations, system 100 encodes the video frames of original video 102 into a latent space to capture patterns and relationships between pixels in order to build hierarchy 106. In some embodiments, system 100 identifies viable anchor frames and builds hierarchy 106 based on these selected anchor frames (e.g., based on the distance between each frame and a selected anchor frame).

In some embodiments, at 108, system 100 selects a group of frames based on hierarchy 106. For example, in some implementations, system 100 selects frame 4, frame 1, frame 7, and frame 10 as a first group. In some implementations, system 100 selects an anchor frame for the selected group of frames and, at 110, generates a mask that defines a region associated with the object of interest in the selected anchor frame. For example, in some implementations, system 100 generates mask 112a corresponding to the region occupied by the muscle car (e.g., the object of interest) in frame 4, the selected anchor frame for the first group of frames. In some embodiments, system 100, at 114, propagates the mask of the selected anchor frame (e.g., mask 112a) to all frames in the selected group (e.g., mask 112a of frame 4 is propagated to frames 1, 7, and 10). In some embodiments, system 100, at 116, provides input 118 to inpainting model 120.

In some embodiments, inpainting model 120 is a video diffusion model (VDM) or a neural radiance field (NeRF). In some implementations, inpainting model 120 is trained by providing inpainting model 120 with training data, introducing noise to the training data, and leveraging a reward function that rewards fixing from a ground truth. In some embodiments, inpainting model 120 accepts a video and an editing prompt as input and generates a modified video as output. In some implementations, system 100 provides the masked anchor frame of the selected group (e.g., masked anchor frame 4 of group 1), the frames of the selected group (e.g., frames 4, 1, 7, and 10), and an indication for the replacement object (e.g., a Barbie Jeep) as input 118 to inpainting model 120. In some embodiments, system 100 provides a plurality of frames comprising masked regions to be inpainted, an inpainting prompt, and an attention guidance frame and/or frames to inpainting model 120. In some embodiments, system 100 provides a masked anchor frame and a plurality of unmasked frames to inpainting model 120, wherein inpainting model 120 infers, based on the masked region of the anchor frame, which portions of the plurality of unmasked frames require inpainting.

In some implementations, system 100 provides an indication for the replacement object as an image, a 3D model, a text prompt, or any other suitable indication for the replacement object in a format suitable for inpainting model 120. It should be appreciated that while FIG. 1A depicts an illustrative example of system 100 leveraging hierarchy 106 to streamline the object replacement process via inpainting model 120, system 100 may leverage hierarchy 106 to streamline any suitable video editing process (e.g., object addition, object removal, object modification, video restoration), and as such, system 100 may provide any suitable input 118 to inpainting model 120. Further, in some implementations, system 100 refrains from, at 114, propagating the mask for the selected anchor frame to all frames in the group and proceeds to provide the masked anchor frame, the unmasked group of frames, and the indication of the replacement object as input 118 to inpainting model 120, which may be configured to output a group of modified frames corresponding to the group of input frames with or without propagating mask 112a to each frame of the input group of frames. Further, it should be appreciated that, in some embodiments, system 100, at 108, may select any number of frames to comprise a group of frames. For example, in some implementations, system 100 selects a single frame to comprise a group of frames and, in some embodiments, system 100 selects all frames of original video 102 to be a group of frames.

In some embodiments, system 100 provides, as a part of input 118, an indication of a frame to use as an attention guidance mechanism. For example, in some implementations, system 100 indicates to inpainting model 120, via input 118, to use the respective selected anchor frame as an attention guidance mechanism. In some embodiments, system 100 selects a frame and/or frames to be used by inpainting model 120 for attention guidance based on hierarchy 106. In some embodiments, while system 100 selects nonlinear groups of frames based on hierarchy 106, system 100 selects a frame and/or frames to be used for attention guidance based on the linear order of the plurality of frames.

In some implementations, system 100 receives output 122, comprising modified/inpainted frames, from inpainting model 120. In some embodiments, system 100, at 123, repeats the previously disclosed processe for other groups. For example, in some implementations, when system 100 determines that only a subset of the plurality of frames requiring inpainting (e.g., due to the determination that the frames contain the object of interest to be replaced) have been output as modified (e.g., inpainted) frames, system 100 returns to 108 where a second group of frames are selected based on hierarchy 106. For example, in some embodiments, when system 100 has selected a first group of frames comprising frames 4, 1, 7, and 10 and has provided the frame/frames with a masked object of the first group to inpainting model 120 and received output 122 comprising modified frames 4, 1, 7, and 10, system 100 returns to 108 where, for example, frames 5, 6, 11, and 12 are selected as a second group. In some implementations, system 100 continues to repeat 108, 110, 114, and 116 until system 100 receives, as output 122 from inpainting model 120, at least one modified frame corresponding to each frame of the plurality of frames requiring inpainting. In some embodiments, system 100 provides a plurality of groups of frames, each having an anchor frame with a masked object and containing the entirety of the plurality of frames requiring inpainting, and the indication of the replacement object as input 118 for inpainting model 120 when inpainting model 120 is configured to receive such an input, thus resulting in inpainting model 120 providing at least one modified frame corresponding to each frame of the plurality of frames requiring inpainting and removing the need to, at 123, repeat the disclosed process for other groups.

In some implementations, system 100, at 124, combines the groups of modified frames received as output 122 from inpainting model 120. For example, in some embodiments, when system 100 selects three groups based on hierarchy 106 (e.g., frames 5, 6, 11, and 12 as group 1, frames 4, 1, 7, and 10 as group 2, and frames 2, 3, 9, and 8 as group 3), system 100 receives three distinct groups of modified frames corresponding to the three selected groups and combines the three groups of modified frames to generate modified video 126. In some implementations, as a part of combining the groups of modified frames received as output, system 100 arranges the modified frames according to their original linear order (e.g., based on tags attached to each frame to retain the original frame order/occurrence) in order to generate modified video 126. In some embodiments, when inpainting model 120 receives all selected groups as a single input, system 100 receives modified video 126 as output 122. In some implementations, when system 100 selects a frame to be a part of more than one group of frames (e.g., selects frame 4 to be included in three groups of frames), system 100 receives more than one modified version of the frame (e.g., three versions of modified frame 4) and must select one of the versions to be included in the output modified video 126, as further discussed in regards to FIG. 1B.

In some embodiments, system 100 receives original video 102, selects a plurality of anchor frames (e.g., based on analyzing the quality of the frames), and modifies original video 102 to generate modified video 126 by inpainting a subset of the frames of original video 102 based on the plurality of anchor frames and a determined modification goal (e.g., received from a user or determined by system 100 based on analyzing original video 102) via a multi-temporal diffusion model. In some implementations, system 100 inpaints specific frames of original video 102 based on a determined relationship between the specific frames and the plurality of anchor frames (e.g., similarity of depicted image data, linear distance from the plurality of anchor frames in either a forward or backward direction). For example, in some embodiments, system 100 accesses original video 102 comprising a plurality of scenes, determines subsets of frames corresponding to each scene, and groups the subsets of frames according to the similarity of the scenes. For example, in some embodiments, when original video 102 comprises a conversation between two people where the video alternates between displaying the first person and the second person, system 100 groups frames containing the first person into a first group and frames containing the second person into a second group.

As shown in FIG. 1B, in some embodiments, system 100 determines a group of duplicate modified frames 128 comprising, for example, modified (mod) frame 4 version 1 from modified group 1, mod frame 4 version 2 from modified group 2, and mod frame 4 version 3 from modified group 3, each modified group corresponding to a received output 122 from inpainting model 120 that received input 118 comprising a respective group of frames. In some implementations, system 100, at 130, selects one of the versions of the modified frame from the group of duplicate modified frames 128 to be used in modified video 126 (e.g., the output of system 100). In some embodiments, system 100 compares each version of the modified frame to determine a preferred frame (e.g., a frame where the replacement object is most accurate to the desired look and/or contains the fewest variations compared to the replacement object in other modified frames. For example, in some implementations, mod frame 4 version 1 has all black wheels (e.g., is missing hub caps) and mod frame 4 version 3 is missing a logo on the backend of the Barbie Jeep and thus, system 100 selects mod frame 4 version 2 as output modified frame 134 and selects mod frame 4 version 1 and mod frame 4 version 3 to be discarded modified frames 132.

As shown in FIG. 1C, in some embodiments, system 100 selects the three topmost frames in hierarchy 106 to be anchor frames for their own respective groups (e.g., the underlying frames of each topmost frame correspond to a respective group). In some implementations, system 100 generates mask 136 corresponding to frame 5, mask 112b corresponding to frame 4, and mask 138 corresponding to frame 2. In some embodiments, system 100 propagates a respective mask (e.g., mask 136, 112b, or 138) to each frame of the respective group of frames by turning, rotating, inverting, or enlarging the respective mask to correspond to the depiction of the object of interest in the frame being masked. In some embodiments, system 100 propagates a respective mask to each frame of the respective group of frames by identifying the location of the object of interest in the frame being masked and overlaying the respective mask accordingly. It should be appreciated that FIG. 1A is an illustrative example of intelligently replacing an object in a video and any of steps 104, 108, 110, and 114 may be performed by inpainting model 120 and/or input 118 may simply comprise original video 102, an indication of the replacement object (e.g., Barbie Jeep), and/or any other suitable editing prompt. For example, in some embodiments, system 100 receives input to both replace an object of interest with a replacement object and remove an object from the background of select frames. Further, for example, in some implementations, system 100 builds hierarchy 106 based on a combined similarity of the respective masked regions corresponding to the respective editing prompts (e.g., similarity of the object of interest masked region and similarity of the object for removal masked region). In some embodiments, system 100 builds respective hierarchies corresponding to the respective editing prompts and leverages inpainting model 120 to generate a group of modified frames based on the original frames, the first editing prompt, and according to the first hierarchy, before leveraging inpainting model 120 to generate a group of twice modified frames based on the group of modified frames, the second editing prompt, and according to the second hierarchy. It should be appreciated that system 100 may receive any number of editing prompts and may perform said editing in any suitable manner according to the disclosed methods.

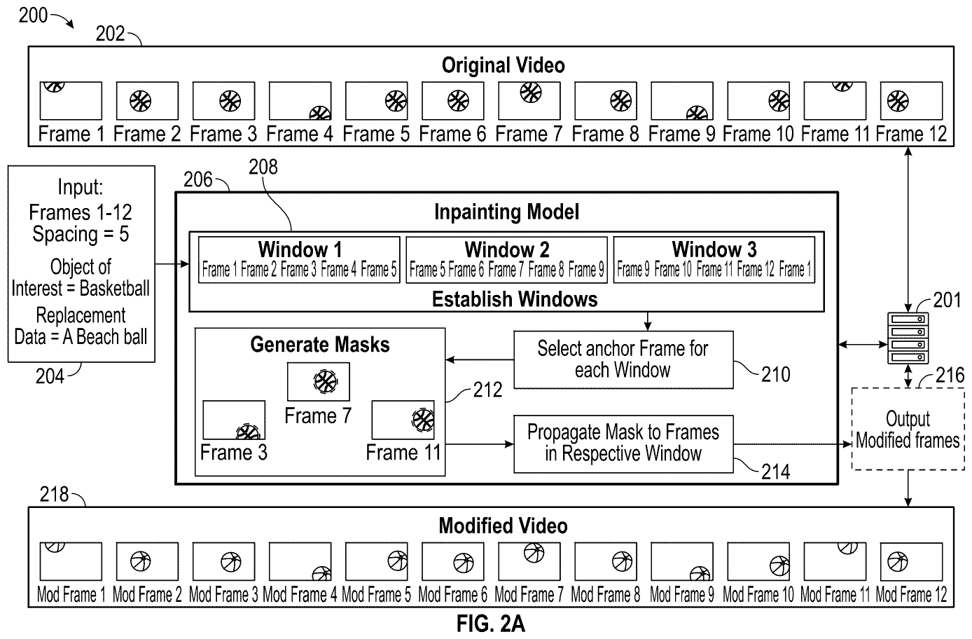

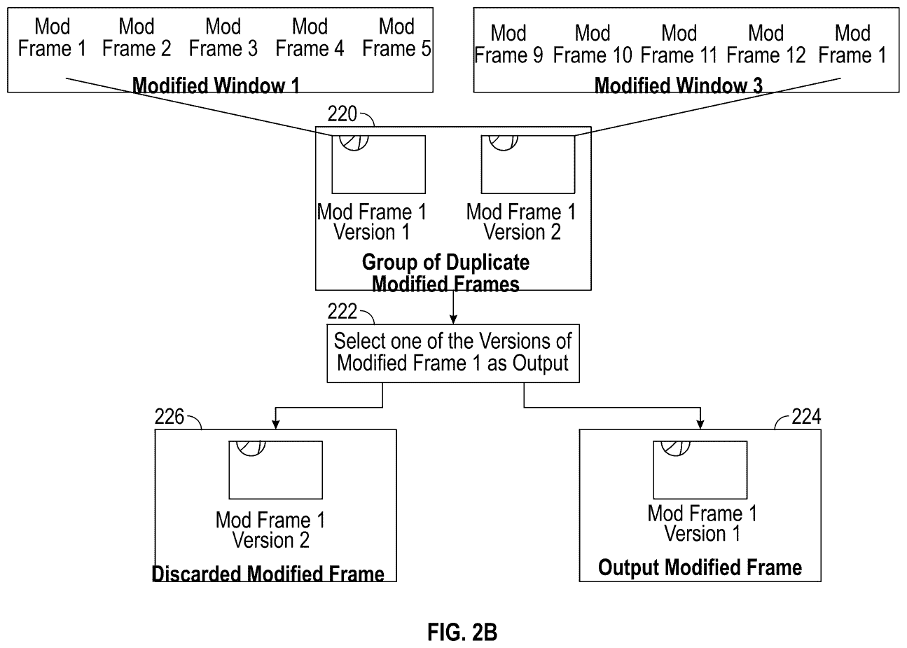

As shown in FIG. 2A, in some embodiments, system 200 (e.g., system 100 from FIGS. 1A-1C), as running on/supported by server 201, accesses original video 202, comprising frames 1-12, or any suitable number of frames. In some embodiments, system 200 accesses original video 202 comprising twelve frames of a basketball bouncing around in response to receiving an input to edit original video 202 (e.g., to replace the basketball with a beachball). In some embodiments, system 200 accesses original video 202 in a routine review of stored videos or based on a random selection of stored videos and determines an editing action to take based on the contents of original video 202. In some implementations, system 200 determines a spacing factor to organize the frames in accordance with, based on any of a number of frames in original video 202, a determined rate of movement and/or change of the object of interest in original video 202, a received user input, a determined resource availability (e.g., bandwidth, energy), or any other suitable reason. In some embodiments, system 200 provides, to inpainting model 206, input 204, comprising frames 1-12 of original video 202, the determined spacing factor (e.g., 5), and an indication of the editing action to be taken, such as a determined object of interest (e.g., the basketball, based on a received user input or analysis of original video 202 by system 200) and replacement data corresponding to the object of interest (e.g., a beachball).

In some implementations, at 208, system 200, via inpainting model 206, establishes windows, such as window 1, window 2, and window 3, based on the number of input frames and the spacing factor received as input 204. In some embodiments, at 210, system 200, via inpainting model 206, selects an anchor frame for each established window and, at 212, generates a mask for each selected anchor frame. In some implementations, at 214, system 200, via inpainting model 206, propagates the generated masks to the respective frames in each anchor frame's respective window and then inpaints the masked regions of each frame to generate output 216, comprising modified frames (e.g., modified frames 1-12). In some implementations, output 216 comprises duplicate modified frames and system 200 selects a frame to be used in modified video 218, as further discussed in regard to FIG. 2B. In some embodiments, system 200, as supported by server 201, uses a sliding window approach to group frames of original video 202. For example, in some implementations, system 200 opts to use a sliding window approach (e.g., as shown in FIG. 2A) based on analyzing original video 202 to determine the type of displayed motion of the object of interest (e.g., linear vs. rotational) and determines that linear motion benefits from use of a sliding window (e.g., while rotational motion benefits from use of hierarchy 106 of FIG. 1A). In some embodiments, system 200 establishes windows 1, 2, and 3 based on hierarchy 106 of FIG. 1A. In some implementations, system 200 utilizes a sliding window approach in place of, in addition to, or based on hierarchy 106 of FIG. 1A.

It should be appreciated that while 208, 210, 212, and 214 are depicted as occurring within inpainting model 206, each of 208, 210, 212, and 214 may be implemented by any suitable mechanism as a part of system 200 to the effect that input 204 provided to inpainting model 206 may be based on the pre-processing of the frames. For example, in some implementations, system 200 provides inpainting model 206 with input 204 comprising a masked anchor frame of a window, the frames from the respective window of the masked anchor frame, and an indication of an editing action to be taken (e.g., replace the basketball with a beachball) in a format acceptable by inpainting model 206. In some embodiments, system 200 continues to provide inpainting model 206 with input corresponding to each respective window until system 200 has received at least one modified frame corresponding to each original frame requiring inpainting. In some embodiments, by leveraging frame analysis and pre-processing along with inpainting model 206, system 200 generates modified video 218 comprising modified frames 1-12 depicting a beachball bouncing around. In some embodiments, system 200 uses an attention guidance mechanism to further refine output 216 by inpainting model 206, where the attention guidance mechanism leverages any of a selected guidance frame, the respective anchor frame for each window (e.g., each anchor frame provides guidance for the frames of its respective window), a plurality of selected frames, the middle frame of the video, a combination of frames, a combination of all selected anchor frames for each window, or any other suitable guidance mechanism or combination thereof.

As shown in FIG. 2B, in some embodiments, system 200 determines a group of duplicate modified frames 220 comprising, for example, mod frame 1 version 1 from modified window 1 and mod frame 1 version 2 from modified window 3. In some implementations, system 200, at 222, selects one of the versions of the modified frame from the group of duplicate modified frames 220 to be used in modified video 218 (e.g., the output of system 200). In some embodiments, system 200 compares each version of the modified frame to determine a preferred frame (e.g., a frame where the replacement object is most accurate to the desired look and/or contains the fewest variations compared to the replacement object in other modified frames). For example, in some implementations, mod frame 1 version 1 appears to depict the beachball in a way that is consistent with the look of the beachball in other modified frames, whereas mod frame 1 version 2 depicts a beachball having incorrect spacing, obscuring the intended look of the beachball. Thus, in some embodiments, system 100 selects mod frame 1 version 1 as output modified frame 224 and selects mod frame 1 version 1 to be discarded modified frame 226.

In some implementations, the shifts or inconsistencies present in the generated modified video (e.g., modified video 126 of FIG. 1A, modified video 218 of FIG. 2A) become more apparent in a longer video due to the fact that, in the process of rendering a frame, its distance from an anchor frame plays a role in ensuring the temporal consistency. In some implementations, the choice of attention guidance can be better formulated with an anchor frame that is closer to the frame being inpainted as compared to the middle frame. In some embodiments, when this association is designed in a hierarchical manner, the fusion of auxiliary attention feature maps can be propagated to ensure temporal consistency. Therefore, in some implementations, the distance from an anchor frame is measured as the similarity of depiction of the object of interest in the plurality of frames.

In some embodiments, the mask of a target object can be populated (e.g., enabled by object detection, etc.) from an initial frame to another frame that may become an anchor frame. For example, in some implementations, each frame in the video can become an anchor frame. In some embodiments, the selection of an anchor frame can depend on different constraints or measurements including object complexity and motion. For instance, in some implementations, the video editing system (e.g., system 100 of FIG. 1A-1C) uses the minimum and maximum distances from a current frame as the framework for anchor frame selection, since it may not always be necessary to select a neighboring frame for fusing the attention feature map. Further, in some embodiments, because the mask has a notable influence on the inpainting results, the video editing system assesses the quality of populated masks (e.g., from the initial frame to a current frame) as part of the process in determining an anchor frame. In some implementations, with an appointed anchor frame, the video inpainting proceeds in a forward direction, a backward direction, or in both directions. In some embodiments, the temporal coherence remains in either direction when a video plays. In some implementations, the hierarchy utilized by the video editing system is analogous to the bi-directional motion estimation in video interpolation, compression, and more.

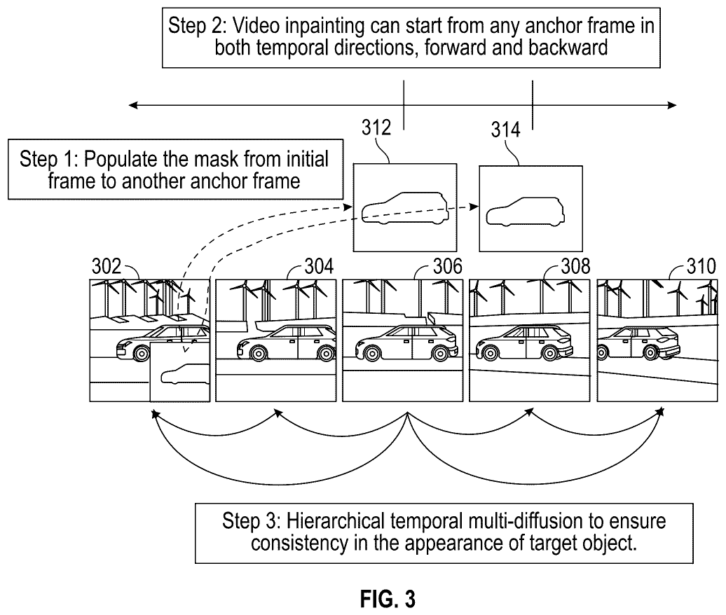

As shown in FIG. 3, in some embodiments, the video editing system (e.g., system 100 of FIGS. 1A-1C) receives frames 302, 304, 306, 308, and 310 as an original video (e.g., original video 102 of FIG. 1A or original video 202 of FIG. 2A). In some implementations, the video editing system receives an original video comprising any number of frames (e.g., 30, 100, etc.) and selects frames 302, 304, 306, 308, and 310 as anchor frames. In some embodiments, the video editing system generates a mask (e.g., mask 312 or 314) for an initial frame (e.g., frame 302) based on received input (e.g., a textual prompt stating “replace the white car with a red car”) and then, in step 1, populates the mask from the initial frame (e.g., frame 302) to another anchor frame (e.g., frame 304). In some embodiments, at step 2, the video editing system initiates video inpainting from any of the selected and masked anchor frames in any temporal direction(s) (e.g., forward and/or backward). In some implementations, at step 3, the video editing system leverages hierarchical temporal multi-diffusion to ensure consistency in the appearance of the target object (e.g., the car).

In some embodiments, hierarchical temporal multi-diffusion reduces middle-frame dominance, which occurs when utilizing a middle-frame attention guidance mechanism, by anchoring the inpainting process to multiple reference frames (e.g., frames 302, 304, 306, 308, and 310 of FIG. 3) rather than relying heavily on a single middle frame, as is done in middle-frame attention guidance. In some implementations, the term hierarchical refers to the fact that the frames are organized in levels or layers of importance. In some embodiments, the diffusion process starts with broader guidance from multiple key anchor frames (e.g., frames 302, 304, 306, 308, and 310) selected by the video editing system based on an analysis of the video frames, and, as the process continues, the diffusion process focuses more specifically on details within smaller groups of frames. In some implementations, this structure allows the inpainting algorithm to maintain a more global view of the entire video and gradually refine the inpainting results with the help of local context from nearby frames, rather than focusing only on the middle frame of the video. In some embodiments, because multiple frames are used to guide the inpainting, the video editing system tracks objects, colors, and positions more accurately across time. In some implementations, the hierarchical approach ensures that the consistency is not maintained just with respect to a single middle frame, but across the entire video, with all the selected anchor frames contributing to the final result. In some embodiments, as the video progresses, the algorithm dynamically adjusts and smooths out the inpainted areas using the anchor frames, thereby preventing the unwanted effects of relying too heavily on one point of reference (e.g., the middle frame) and ensuring more temporal coherence throughout.

In some implementations, as an alternative to hierarchical temporal multi-diffusion, a sliding window is integrated into the temporal multi-diffusion. In some embodiments, similar to the hierarchical use case, the video editing system (e.g., system 100 of FIGS. 1A-1C) first populates the object mask to an anchor frame. In some implementations, for each sliding window the anchor frame can be any frame in the window; therefore the anchor frame does not have to be the first frame or the middle frame in the window. In some embodiments, the inpainting with the sliding window mechanism can be initiated from an anchor frame in a forward direction, a backward direction, or in both directions. In some implementations, the window size (e.g., the number of frames included in a window) can vary during the inpainting. In some embodiments, within each sliding window having a selected anchor frame, the hierarchical temporal multi-diffusion method previously discussed in regard to FIG. 3 is applied, which is especially useful when inpainting a long video.

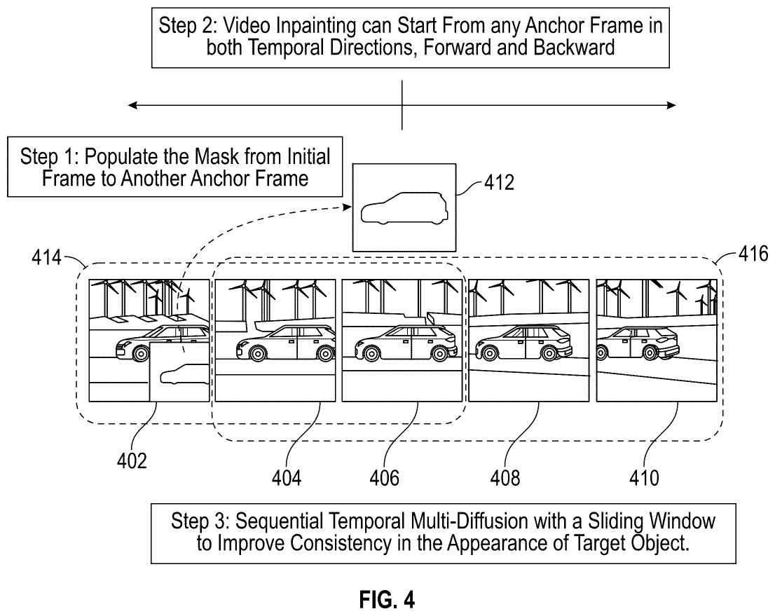

As shown in FIG. 4, in some embodiments, the video editing system (e.g., system 100 of FIGS. 1A-1C) receives frames 402, 404, 406, 408, and 410 as an original video (e.g., original video 102 of FIG. 1A or original video 202 of FIG. 2A). In some implementations, the video editing system receives an original video comprising any number of frames (e.g., 30, 100, etc.) and selects frames 402, 404, 406, 408, and 410 as anchor frames. In some embodiments, the video editing system generates a mask (e.g., mask 412) for an initial frame (e.g., frame 402) based on received input (e.g., a textual prompt stating “Replace the white car with a red car”) and then, in step 1, populates the mask from the initial frame (e.g., frame 402) to another anchor frame (e.g., frame 404). In some embodiments, at step 2, the video editing system initiates video inpainting from any of the selected and masked anchor frames in a forward direction, a backward direction, or in both directions. In some implementations, at step 3, the video editing system leverages sequential temporal multi-diffusion with a sliding window to improve consistency in the appearance of a target object (e.g., the white car). For example, in some embodiments, the video editing system defines window 414 as including frames 402, 404, and 406 and defines window 416 as including frames 404, 406, 408, and 410. Further, for example, in some implementations, the video editing system will assign the same frame to multiple windows to be inpainted, resulting in multiple modified versions of a frame being generated and requiring the video editing system to select a single version for use in the generated modified video (e.g., modified video 126 of FIG. 1A and modified video 218 of FIG. 2A), as further discussed in regards to FIG. 1B and FIG. 2B.

In some embodiments, the sliding window approach improves consistency in video inpainting by processing frames within smaller, localized windows of the video, rather than relying on the entire video sequence or just a single middle frame. In some implementations, this method allows for more controlled and precise inpainting decisions within each window, which ultimately enhances both spatial and temporal consistency. In some embodiments, the sliding window divides the video into smaller groups of frames (e.g., windows) and, within each window, frames are inpainted based on the information from nearby frames (e.g., anchor frames) within that same window. In some implementations, this allows the algorithm to make more accurate inpainting decisions because it is focused on a limited number of frames that are closely related in time. In some implementations, in the sliding window approach, the anchor frame (e.g., the frame used as a reference for guiding the inpainting process) is located anywhere within the window, not just in the middle, which gives the algorithm more flexibility and allows it to start the inpainting process from the frame that provides the best contextual information for that particular segment of the video. In some embodiments, the sliding window “slides” across the video sequence, meaning that the windows overlap. For example, in some implementations, a window might include frames 1 to 5, and the next window might cover frames 3 to 7, thus ensuring that the frames at the edges of each window are refined multiple times as they appear in multiple windows. In some embodiments, this process reduces the chances of abrupt changes between windows, thereby improving overall smoothness and consistency across the entire video. In some implementations, by working incrementally, the algorithm can refine its inpainting decisions based on previous windows, leading to a smoother and more consistent final output. In some embodiments, sliding windows are particularly useful for handling longer videos because they break down the video into manageable chunks. For example, in some implementations, each chunk can be processed without introducing significant artifacts or shifts that typically arise when inpainting is done based on a single global reference (e.g., the middle frame).

In some implementations, when reducing color shifts with the use of middle-frame attention guidance, noticeable variations (e.g., positioning, shape, size) from the object in the original video (e.g., original video 102 of FIG. 1A) as compared to the modified video (e.g., modified video 126 of FIG. 1A) are created. In some embodiments, a modified video generated without the use of middle-frame attention guidance exhibits better consistency in various aspects, as compared to the object in the original video. In some embodiments, such variations did not arise since there was no bias or dominance by the statistics of the middle frame. In some implementations, in order to overcome the color inconsistency, the temporal multi-diffusion process integrates color transfer when inconsistency is detected in the inpainting results. For example, in some embodiments, a combination of de-colorization and re-colorization of the frames is leveraged to improve the color consistency. In some embodiments, the process of detecting color inconsistency and initiating color transfer is applicable to an inpainted object only, or an entire frame. In some implementations, the use of color transfer is combined with the proposed approaches that leverage using anchor frames in regard to FIGS. 3 and 4.

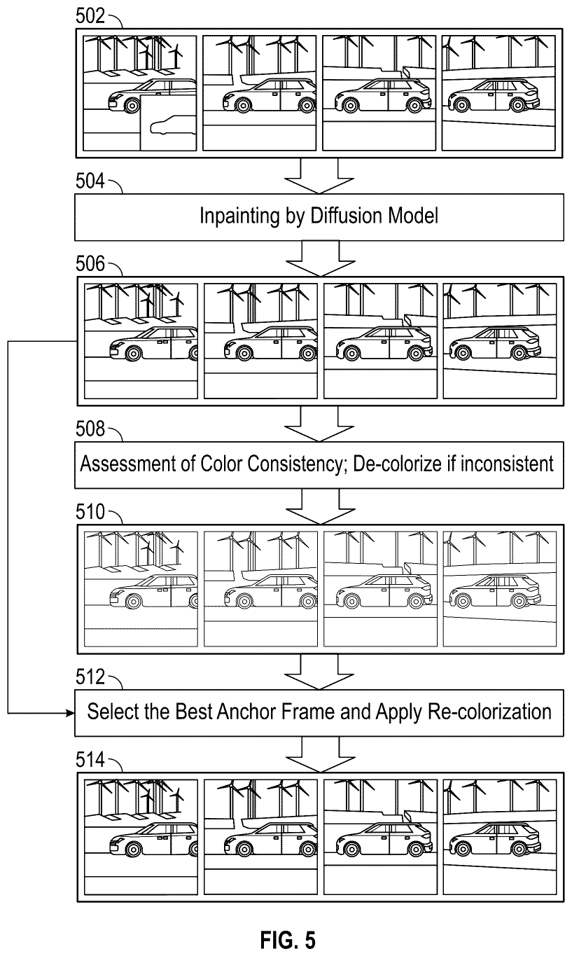

As shown in FIG. 5, in some embodiments, the video editing system (e.g., system 100 of FIGS. 1A-1C) accesses video 502 (e.g., original video 102 of FIG. 1A) and retrieves instruction to edit video 502 in some manner (e.g., replace a white car with a red car). In some implementations, the video editing system, at 504, inpaints video 502 by a diffusion model and generates modified video 506 (e.g., modified video 126 of FIG. 1A). In some embodiments, the video editing system, at 508, assesses the color consistency of modified video 506 and, if the color is determined to be inconsistent, de-colorizes modified video 506 to generate de-colorized video 510. In some embodiments, when the video editing system determines that the color of modified video 506 is consistent, the video editing system refrains from de-colorizing modified video 506 and proceeds to 512 where the video editing system selects the best anchor frame from modified video 506 and applies re-colorization to generate re-colorized video 514. In some embodiments, after generating de-colorized video 510, the video editing system proceeds to 512 where the video editing system selects the best anchor frame from de-colorized video 510 and applies re-colorization in order to generate re-colorized video 514.

In some embodiments, color transfer ensures a more uniform color appearance in video inpainting by detecting and correcting color inconsistencies between frames, particularly in areas where artifacts or color shifts occur. In some implementations, the color transfer process involves adjusting the colors of frames or regions within frames to maintain a consistent color palette across the entire video. In some embodiments, color transfer involves identifying color inconsistencies, such as, for example, color artifacts or variations that occur due to slight changes in lighting, motion, or the inpainting process itself. In some implementations, these inconsistencies can make parts of the video look unnatural, especially when consecutive frames display different color tones for the same object or region. In some embodiments, the color transfer process detects these inconsistencies by comparing the colors in various frames, identifying areas where the colors don't match the overall tone or where color shifts occur. In some embodiments, the color transfer process starts with de-colorization, where the colors of the inpainted regions are neutralized or removed, which helps remove any unwanted color artifacts or incorrect color assignments that may have been introduced during the inpainting process. In some embodiments, the inpainted region of all inpainted frames are de-colorized, whereas in some implementations, only inpainted regions identified as containing an inconsistency of some sort are de-colorized. In some implementations, after de-colorization, re-colorization is applied which involves transferring the correct colors from reference frames or surrounding areas to the de-colorized regions, ensuring that the colors are consistent and match the rest of the video. In some embodiments, by reapplying colors that are consistent with the original video's color scheme, the model ensures that the inpainted regions blend seamlessly with their surroundings.

In some embodiments, in order to maintain temporal consistency, color transfer processes align the color palette between different frames of the video. For example, in some implementations, when an object appears in multiple frames, the color transfer process ensures that the object's color stays consistent across all those frames, preventing it from changing slightly between frames. In some embodiments, the algorithm uses reference frames or anchor frames to guide this coloring process, ensuring that colors from key frames are used as a standard to match and adjust the colors in neighboring frames. In some implementations, the color transfer method adjusts the overall color tone of a frame to ensure it fits the general color scheme of the generated modified video. For instance, in some embodiments, when the video has a particular lighting condition, such as a sunset, the algorithm ensures that the same warm tones are applied uniformly across all frames. In some implementations, for smaller areas or specific objects, local color transfer ensures that inpainted sections retain the same color as surrounding objects, thus preventing jarring transitions between frames or between inpainted areas and the original parts of the frame. In some embodiments, the color transfer method preserves gradients such as smooth changes in color that occur naturally across an object or scene. In some implementations, by preserving these gradients, the color transfer process ensures that the video maintains a natural look, avoiding abrupt changes in color that might otherwise occur at the boundaries of inpainted regions. In some embodiments, color transfer works in tandem with hierarchical temporal multi-diffusion and/or the sliding window approach as discussed in regard to FIGS. 3 and 4. In some implementations, once a video has been inpainted using these diffusion methods, color transfer is applied to smooth out any remaining color differences, ensuring that the final output has a uniform appearance across frames. In some embodiments, the color transfer process is particularly important when the video editing system is leveraging the sliding window approach, where the overlap between windows might create slight color differences. In some implementations, the color transfer method helps smooth out these differences, ensuring that frames from different windows have matching and consistent color tones.

FIG. 6 shows generalized embodiments of illustrative user equipment devices 600 and 601. For example, user equipment device 600 may be a smartphone device (e.g., user devices 104a-104d of FIGS. 1A-1E). In another example, user equipment system 601 may be a user television equipment system. User television equipment system 601 may include set-top box 616. Set-top box 616 may be communicatively connected to microphone 618, speaker 614, and display 612. In some embodiments, microphone 618 may receive voice commands for a media or communication application. In some embodiments, display 612 may be a television display or a computer display. In some embodiments, set-top box 616 may be communicatively connected to user input interface 610. In some embodiments, user input interface 610 may be a remote control device or a touchscreen. Set-top box 616 may include one or more circuit boards. In some embodiments, the circuit boards may include processing circuitry, control circuitry, and storage (e.g., RAM, ROM, hard disk, removable disk, etc.). In some embodiments, the circuit boards may include an input/output path. More specific implementations of user equipment devices are discussed below in connection with FIG. 7. Each one of user equipment device 600 and user equipment system 601 may receive content and data via input/output (I/O) path 602. In some embodiments, I/O path 602 is I/O circuitry. I/O path 602 may provide content (e.g., messages, calls, broadcast programming, on-demand programming, Internet content, content available over a local area network (LAN) or wide area network (WAN), and/or other content) and data to control circuitry 604, which includes processing circuitry 606 and storage 608. Storage 608 comprises the instructions for intelligently selecting anchor frames to edit videos using inpainting and/or diffusion models as described in FIGS. 1A-5, when executed by processing circuitry 606. Control circuitry 604 may be used to send and receive commands, requests, and other suitable data using I/O path 602, which may comprise I/O circuitry. I/O path 602 may connect control circuitry 604 (and specifically processing circuitry 606) to one or more communications paths (described below). I/O functions may be provided by one or more of these communications paths, but are shown as a single path in FIG. 6 to avoid overcomplicating the drawing.

Control circuitry 604 may be based on any suitable processing circuitry such as processing circuitry 606. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 604 executes instructions stored in memory (e.g., storage 608) for intelligently selecting anchor frames to edit videos using inpainting and/or diffusion models as described in FIGS. 1A-5. Specifically, control circuitry 604 may perform the functions discussed above and below. In some implementations, any action performed by control circuitry 604 may be based on instructions received from the video editing system.

In client/server-based embodiments, control circuitry 604 may include communications circuitry suitable for communicating with a communications application server or other networks or servers. The instructions for carrying out the above-mentioned functionality may be stored on a server (which is described in more detail in connection with FIG. 7). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 7). In addition, communications circuitry may include circuitry that enables peer-to-peer communication of user equipment devices, communication between a user and a contact of the user, or communication of user equipment devices in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of content described herein as well as original video 102 of FIG. 1A, original video 202 of FIG. 2A, and/or any editing data such as replacement images or 3D models as data described above. Nonvolatile memory may also be used (e.g., to launch a boot-up routine and other instructions). Cloud-based storage, described in relation to FIG. 7, may be used to supplement storage 608 or instead of storage 608.

Control circuitry 604 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 604 may also include scaler circuitry for upconverting and downconverting content into the preferred output format of user equipment 600. Circuitry 604 may also include digital-to-analog converter circuitry and analog-to-digital converter circuitry for converting between digital and analog signals. The tuning and encoding circuitry may be used by user equipment device 600, 601 to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from user equipment device 600, the tuning and encoding circuitry (including multiple tuners) may be associated with storage 608.

A user may send instructions to control circuitry 604 using user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of each one of user equipment device 600 and user equipment system 601. For example, display 612 may be a touchscreen or touch-sensitive display. In such circumstances, user input interface 610 may be integrated with or combined with display 612. Display 612 may be one or more of a monitor, a television, a display for a mobile device, or any other type of display. A video card or graphics card may generate the output to display 612. The video card may be any processing circuitry described above in relation to control circuitry 604. The video card may be integrated with the control circuitry 604. Speakers 614 may be provided as integrated with other elements of each one of user equipment device 600 and user equipment system 601 or may be stand-alone units. The audio component of videos and other content displayed on display 612 may be played through the speakers 614. In some embodiments, the audio may be distributed to a receiver (not shown), which processes and outputs the audio via speakers 614.

The system for intelligently selecting anchor frames to edit videos using inpainting and/or diffusion models as described in FIGS. 1A-5 may be implemented using any suitable architecture. For example, it may be a stand-alone system wholly-implemented on each one of user equipment device 600 and user equipment system 601. In such an approach, instructions of the system are stored locally (e.g., in storage 608), and data for use by the system is downloaded on a periodic basis (e.g., from an out-of-band feed, from an Internet resource, or using another suitable approach). Control circuitry 604 may retrieve instructions for the system from storage 608 and process the instructions to perform the intelligent selection of anchor frames for editing videos using inpainting and/or diffusion models. Based on the processed instructions, control circuitry 604 may determine what action to perform when input is received from user input interface 610. For example, movement of a cursor on a display up/down may be indicated by the processed instructions when user input interface 610 indicates that an up/down button was selected.

In some embodiments, the system for intelligently selecting anchor frames to edit videos using inpainting and/or diffusion models is a client/server-based application. Data for use by a thick or thin client implemented on each one of user equipment device 600 and user equipment system 601 is retrieved on-demand by issuing requests to a server remote to each one of user equipment device 600 and user equipment system 601. In one example of a client/server-based guidance application, control circuitry 604 runs a web browser that interprets web pages provided by a remote server. For example, the remote server may store the instructions for the video editing application (e.g., Adobe) in a storage device. The remote server may process the stored instructions using circuitry (e.g., control circuitry 604) to perform the operations discussed in connection with FIGS. 1A-5 and 8.

In some embodiments, the system for intelligently selecting anchor frames to edit videos using inpainting and/or diffusion models may be downloaded and interpreted or otherwise run by an interpreter or virtual machine (run by control circuitry 604). In some embodiments, the system for intelligently selecting anchor frames to edit videos using inpainting and/or diffusion models may be encoded in the ETV Binary Interchange Format (EBIF), received by the control circuitry 604 as part of a suitable feed, and interpreted by a user agent running on control circuitry 604. For example, the system for intelligently selecting anchor frames to edit videos using inpainting and/or diffusion models may be an EBIF application. In some embodiments, the system for intelligently selecting anchor frames to edit videos using inpainting and/or diffusion models may be defined by a series of JAVA-based files that are received and run by a local virtual machine or other suitable middleware executed by control circuitry 604. In some of such embodiments (e.g., those employing MPEG-2 or other digital media encoding schemes), the system for intelligently selecting anchor frames to edit videos using inpainting and/or diffusion models may be, for example, encoded and transmitted in an MPEG-2 object carousel with the MPEG audio and video packets of a program.

FIG. 7 shows illustrative devices and systems for intelligently selecting anchor frames to edit videos using inpainting and/or diffusion models, in accordance with some embodiments of this disclosure. User equipment devices 707, 708, 710 (e.g., user device 101) may be coupled to communication network 706. Communication network 706 may be one or more networks including the Internet, a mobile phone network, mobile voice or data network (e.g., a 4G or LTE network), cable network, public switched telephone network, or other types of communication network or combinations of communication networks. Paths (e.g., depicted as arrows connecting the respective devices to the communication network 706) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 7 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 706.

System 700 includes a media content source 702 and a server 704, which may comprise or be associated with database 705. Communications with media content source 702 and server 704 may be exchanged over one or more communications paths but are shown as a single path in FIG. 7 to avoid overcomplicating the drawing. In addition, there may be more than one of each of media content source 702 and server 704, but only one of each is shown in FIG. 7 to avoid overcomplicating the drawing. If desired, media content source 702 and server 704 may be integrated as one source device.

In some embodiments, server 704 may include control circuitry 711 and a storage 714 (e.g., RAM, ROM, Hard Disk, Removable Disk, etc.) which may store instructions for a video editing application that enables the various methods as disclosed in FIGS. 1-5 to be performed. Server 704 may also include an input/output path 712. I/O path 712 may provide device information, or other data, over a local area network (LAN) or wide area network (WAN), and/or other content and data to the control circuitry 711, which includes processing circuitry, and storage 714. The control circuitry 711 may be used to send and receive commands, requests, and other suitable data using I/O path 712, which may comprise I/O circuitry. I/O path 712 (e.g., I/O circuitry) may connect control circuitry 704 (and specifically processing circuitry) to one or more communications paths.

Control circuitry 711 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 711 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 711 executes instructions for an emulation system application stored in memory (e.g., the storage 714). Memory may be an electronic storage device provided as storage 714 that is part of control circuitry 711.

Server 704 may retrieve guidance data from media content source 702, process the data as will be described in detail below, and forward the data to user equipment devices 707, 708 and 710. Media content source 702 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Media content source 702 may be the originator of content (e.g., a television broadcaster, a Webcast provider, etc.) or may not be the originator of content (e.g., an on-demand content provider, an Internet provider of content of broadcast programs for downloading, etc.). Media content source 702 may include cable sources, satellite providers, on-demand providers, Internet providers, over-the-top content providers, or other providers of content. Media content source 702 may also include a remote media server used to store different types of content (including video content selected by a user), in a location remote from any of the client devices. Media content source 702 may also provide metadata that can be used to identify important segments of media content as described above.

Client devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices (such as, e.g., server 704), which may be located centrally or at distributed locations, that provide cloud-based services to various types of users and devices connected via a network such as the Internet via communication network 706. In such embodiments, user equipment devices may operate in a peer-to-peer manner without communicating with a central server.

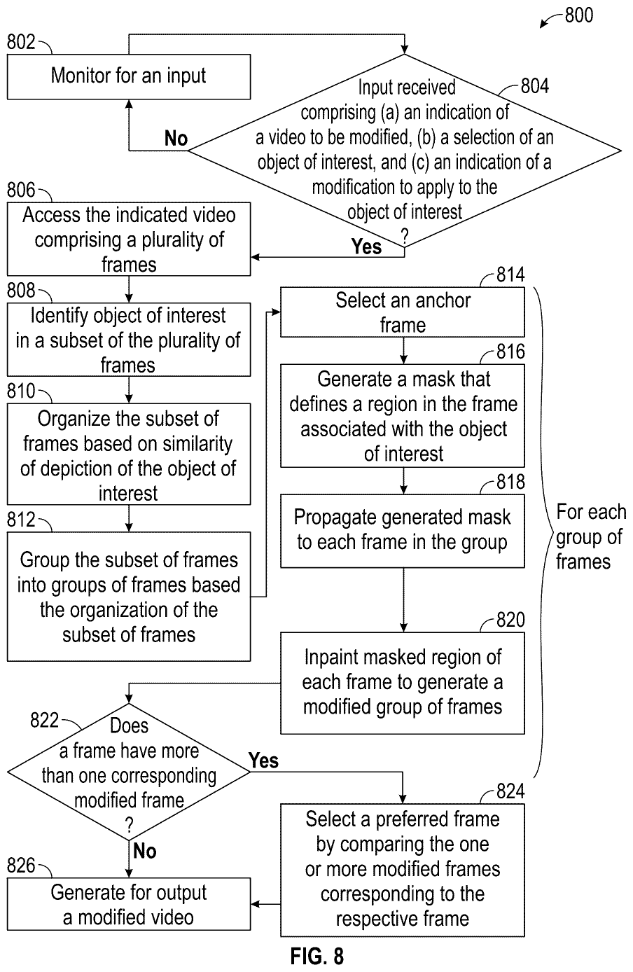

FIG. 8 is flowchart of detailed illustrative process 800 for intelligently selecting anchor frames to edit videos using inpainting and/or diffusion models, in accordance with some embodiments of this disclosure. Process 800 may be implemented at least in part by, for example, control circuitry 604 of FIG. 6, I/O path 602 (e.g., circuitry) of FIG. 6, and/or control circuitry 711 of FIG. 7. In various embodiments, the individual steps of process 800 may be implemented by one or more components of the devices and applications of FIGS. 1-7. Although the present disclosure may describe certain steps of process 800 (and of other processes described herein) as being implemented by certain components of the devices and applications of FIGS. 1-7, this is for purposes of illustration only, and it should be understood that other components of the devices and systems of FIGS. 1-7 may implement those steps instead. In addition, one or more steps of process 800 may be incorporated into or combined with one or more steps of any other process or embodiment.

Process 800 begins at 802, where the control circuitry (e.g., control circuitry 604 of FIG. 6 and/or control circuitry 711 of FIG. 7), monitors for an input (e.g., via I/O path 712). At 804, the control circuitry determines whether an input comprising (a) an indication of a video to be modified, (b) a selection of an object of interest, and (c) an indication of a modification to apply to the object of interest has been received. If, at 804, the control circuitry determines that an input has not been received (e.g., 804=No), process 800 returns to 802. If, at 804, the control circuitry determines that an input has been received (e.g., 804=Yes), process 800 proceeds to 806 where the control circuitry accesses the video comprising a plurality of frames as indicated by the received input. At 808, the control circuitry identifies the object of interest in a subset of the plurality of frames and, at 810, the control circuitry organizes the subset of frames based on a determined similarity of depiction of the object of interest within the frames. At 812, the control circuitry groups the subset of frames into groups based on the organization of the subset of frames (e.g., as organized at 810). At 814, for each group of frames (e.g., as grouped at 812), the control circuitry selects an anchor frame. At 816, the control circuitry generates a mask that defines a region in the anchor frame associated with the object of interest. At 818, the control circuitry propagates the generated mask to each frame in the respective group, and, at 820, inpaints the masked region of each frame to generate a modified group of frames. At 822, the control circuitry determines if a frame from the subset of frames has more than one corresponding modified frame. If, at 822, the control circuitry determines that a frame has more than one corresponding modified frame (e.g., 822=Yes), process 800 proceeds to 824, where the control circuitry selects a preferred frame by comparing the one or more modified frames corresponding to the respective frame and then, at 826, generates for output a modified video (e.g., comprising the selected preferred frame). If, at 822, the control circuitry determines that a frame does not have more than one corresponding modified frame (e.g., 822=No), process 800 proceeds to 826, where the control circuitry generates for output a modified video (i.e., by arranging the modified frames of the modified group of frames according to an original chronological order of the respective original frame each modified frame was derived from). In some embodiments, control circuitry causes the modified video to be stored using memory circuitry and/or causes the modified video to be output using I/O circuitry (e.g., I/O path 712).

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
accessing a video;
receiving an input comprising: (a) a selection of an object of interest within a frame, and (b) an indication to apply a modification to the object of interest in a plurality of frames of the video that depict the object of interest;
grouping the plurality of frames into a plurality of groups of frames based on similarity of depiction of the object of interest in the plurality of frames;
for each respective group of frames of the plurality of groups:
selecting at least one respective anchor frame;
generating a respective mask that defines a region depicting at least a portion of the object of interest in the at least one respective anchor frame;
inpainting the object of interest within each frame of the plurality of frames using an inpainting artificial intelligence model to generate a respective group of modified frames; and
generating for output a modified video based on each respective group of modified frames.

2. The method of claim 1, wherein the grouping the plurality of frames into the plurality of groups of frames is further based on a linear order of occurrence of the plurality of frames in the video.

3. The method of claim 1, wherein the grouping the plurality of frames into the plurality of groups of frames comprises organizing the plurality of frames into a hierarchical order based on the similarity of depiction of the object of interest in the plurality of frames.

4. The method of claim 1, wherein:
the inpainting artificial intelligence model comprises a temporal multi-diffusion model that is configured to receive as input: a subset of frames, an indication of anchor frames within the subset of frames, the respective masked region of each anchor frame, and replacement data for the object of interest.

5. The method of claim 4, wherein the temporal multi-diffusion model leverages at least one of (a) a middle-frame attention guidance mechanism for the plurality of frames, (b) a respective anchor frame attention guidance mechanism for each respective group of the plurality of groups of frames, or (c) a comprehensive attention guidance mechanism based on a subset of frames of the plurality of frames.

6. The method of claim 1, wherein:
a first respective group of modified frames comprises a first modified particular frame corresponding to a particular frame;
a second respective group of modified frames comprises a second modified particular frame corresponding to the particular frame; and
the generating for output the modified video comprises:
comparing the first modified particular frame to the second modified particular frame to identify a preferred modified frame; and
selecting the preferred modified frame to be used in the modified video.

7. The method of claim 1, wherein the receiving: (a) the selection of the object of interest within the frame, and (b) the request for applying the modification to the object of interest in the plurality of frames of the video that depict the object of interest comprises:
receiving a text prompt indicating the object of interest to be modified and an indication of a specific modification to be made to the object of interest.

8. The method of claim 1, further comprising:
determining the similarity of depiction of the object of interest in the plurality of frames by:
generating a preliminary mask that defines a shape of the object of interest in an propagating the preliminary mask to each frame of the plurality of frames;
and comparing the masked region of each frame to determine the similarity of depiction of the object of interest in the plurality of frames.

9. The method of claim 1, wherein the selecting the at least one respective anchor frame is based on at least one of an object of interest complexity, an object of interest motion pattern, a linear distance between the respective anchor frame and each frame in the respective group, or similarity of the depiction of the object of interest in the at least one respective anchor frame as compared to the other frames in the respective group.

10. The method of claim 1, wherein the respective mask defines a region depicting the entirety of the object of interest.

11. The method of claim 1, further comprising: propagating the respective mask of each anchor frame to each frame of the respective group of frames to define a respective masked region to be inpainted for each frame, wherein:
the respective masked region of each frame corresponds to a location and shape of the respective mask of the respective anchor frame; and
the inpainting the object of interest within each frame of the plurality of frames using the inpainting artificial intelligence model comprises inpainting the respective masked region of each frame.

12. The method of claim 11, wherein the propagating the respective mask of each anchor frame to each frame of the respective group comprises:
identifying the object of interest within each frame of the respective group;
overlaying the shape of the respective mask over the identified object of interest within each frame; and
defining the masked region based on the overlayed shape.

13. The method of claim 1, wherein the inpainting artificial intelligence model infers regions to be inpainted within each frame of a respective group of frames based on the respective anchor frame of the group of frames and the respective masked region of the respective anchor frame.

14. A system comprising:
control circuitry configured to:
access a video;
Input/Output (I/O) circuitry configured to:
receive an input comprising: (a) a selection of an object of interest within a frame, and (b) an indication to apply a modification to the object of interest in a plurality of frames of the video that depict the object of interest;
wherein the control circuitry is further configured to:
group the plurality of frames into a plurality of groups of frames based on similarity of depiction of the object of interest in the plurality of frames;
for each respective group of frames of the plurality of groups:
select at least one respective anchor frame;
generate a respective mask that defines a region depicting at least a portion of the object of interest in the at least one respective anchor frame; and
inpaint the object of interest within each frame of the plurality of frames using an inpainting artificial intelligence model to generate a respective group of modified frames; and
wherein the I/O circuitry is further configured to:
output a modified video based on each respective group of modified frames.

15. The system of claim 14, wherein the control circuitry is further configured to group the plurality of frames into the plurality of groups of frames based on a linear order of occurrence of the plurality of frames in the video.

16. The system of claim 14, wherein the control circuitry is further configured to group the plurality of frames into the plurality of groups of frames by organizing the plurality of frames into a hierarchical order based on the similarity of depiction of the object of interest in the plurality of frames.

17. The system of claim 14, wherein:
the inpainting artificial intelligence model comprises a temporal multi-diffusion model that is configured to receive as input: a subset of frames, an indication of anchor frames within the subset of frames, the respective masked region of each anchor frame, and replacement data for the object of interest.

18. The system of claim 17, wherein the temporal multi-diffusion model leverages at least one of (a) a middle-frame attention guidance mechanism for the plurality of frames, (b) a respective anchor frame attention guidance mechanism for each respective group of the plurality of groups of frames, or (c) a comprehensive attention guidance mechanism based on a subset of frames of the plurality of frames.

19. The system of claim 14, wherein:
a first respective group of modified frames comprises a first modified particular frame corresponding to a particular frame;
a second respective group of modified frames comprises a second modified particular frame corresponding to the particular frame; and
the control circuitry is further configured to:
compare the first modified particular frame to the second modified particular frame to identify a preferred modified frame; and
select the preferred modified frame to be used in the modified video.

20. The system of claim 14, wherein the input comprising: (a) the selection of the object of interest within the frame, and (b) the request for applying the modification to the object of interest in the plurality of frames of the video that depict the object of interest comprises a text prompt indicating the object of interest to be modified and an indication of a specific modification to be made to the object of interest.

21-65. (canceled)
